(19) United States
(12) Patent Application Publication
(10) Pub. No.: US 2010/0079778 A1
(43) Pub. Date: Apr. 1, 2010

(54) PRINT SETTING APPLICATION PROGRAM, PRINT CONTROL PROGRAM, PRINT SETTING APPLICATION APPARATUS, AND PRINT SETTING APPLICATION METHOD

(75) Inventor: Yuji Kohama, Sapporo-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/566,552

(22) Filed: Sep. 24, 2009

(30) Foreign Application Priority Data
Sep. 29, 2008 (JP) 2008-249807

(51) Int. Cl. H04N 1/60

(52) U.S. Cl. 358/1.9

(57) ABSTRACT

A print setting application apparatus includes: a print job data storage processing section that causes a predetermined storage medium to store print job data that designates a print target; a print setting acquiring section that acquires information that indicates that at least one of a plurality of print settings that can be applied to the print target has been changed; and a display controlling section that causes a predetermined display unit to display print-setting-application-completed information, which shows a result of application of the changed print setting to the print target when the print setting has been changed.

### CROSS REFERENCES TO RELATED APPLICATIONS

The entire disclosure of Japanese Patent Application No. 2008-249807, filed Sep. 29, 2008 is expressly incorporated by reference herein.

### BACKGROUND

1. Technical Field

The present invention relates to a technique for determining print setting.

2. Related Art

Recently, XML paper specification (XPS), which is a platform devised to deal with documents electronically, has started to be used in various scenes and situations. An example of an XPS-related print technique is described in JP-A-2008-33812. According to the XPS specification mentioned therein, information called as a print ticket is set for each of layers corresponding to a job, documents, and pages, thereby making it possible to make print setting for a print target in each layer. An XPS document, which is written in a format conforming to the XPS specification, can be created with the use of an application program, a virtual printer that functions in cooperation with an application program (XPS document writer) or the like. It is possible to print an XPS document under the control of a printer driver that conforms to the XPS specification. In the following description of this specification, such a printer driver that conforms to the XPS specification is referred to as “XPS printer driver”.

In typical old electronic document printing devised earlier than XPS document printing, a printer driver is configured to be capable of accepting print setting for using functions of a printer. For example, the printer driver receives an instruction for implementing a stamp mark superposition function, an enlarging/contracting function, a Nup function (i.e., a function for printing N-number of pages on a surface of a single sheet of recording target medium such as printing paper, where N is an integer of two or greater), and the like. While utilizing the instructed function, the printer driver performs processing for printing a print target that has been created by means of an application program.

An XPS printer driver includes a plurality of filters each of which corresponds to one of various print settings. The XPS printer driver processes an XPS document, which is a print target, by means of each filter so as to generate print data to which the corresponding print setting has been applied. In the operation of an existing XPS printer driver, the sequential order of the processing of an XPS document with the use of the plurality of filters has been fixed in advance. Therefore, it is not possible to change the sequential order thereof. In addition, a filter that renders an XPS document that is written with XML into data conforming to bitmap format is provided as the last one of the plurality of filters that perform filtering in the fixed sequential order. After the rendering processing performed by the last filter, the processed data is immediately transferred to a printer. For this reason, an XPS printer driver of related art has the following disadvantage; it is inevitably necessary to pre-determine print setting in an irrevocable manner before the start of the processing of the XPS printer driver; that is, it is not possible to change print setting after the start of the processing of the XPS printer driver.

### SUMMARY

An advantage of some aspects of the invention is to provide a technique for making it possible to change print setting after the issuance of a print job.

In order to overcome the disadvantage explained above without any limitation thereto, the following print setting application technique is provided. Print job data that designates a print target is stored into a predetermined storage medium. When at least one of a plurality of print settings that can be applied to the print target has been changed, the changed print setting is applied to the print target while making reference to the print job data stored in the storage medium. Then, print-setting-application-completed information, which shows a result of application of the changed print setting to the print target, is displayed on a predetermined display unit. That is, since the print job data generated as a result of the issuance of a print job on the basis of processing of an application program is stored in the predetermined storage medium, it is possible to acquire the print-setting-application-completed information showing a result of application of the print setting by referring to the stored print job data at each time when the print setting is changed. For this reason, even after the issuance of a print job, it is still possible to change print setting into a desired setting state.

According to an aspect of the invention, it is possible to redo and repeat the application of print setting all over again any number of times by referring to the print job data that is stored in the predetermined storage medium at each time when the print setting is changed. Therefore, even after the execution of irreversible filter processing (e.g., conversion of vector data into bitmap data, processing in fixed sequential order that has been determined in advance, or the like), a print setting application technique according to an aspect of the invention makes it possible to redo and repeat the application of print setting all over again any number of times.

In a print setting application technique according to an aspect of the invention, a print job data storage processing function can be embodied in various manners or modes as long as it is possible to store print job data that enables the generation of an image that shows a print target into a predetermined storage medium. Although the print job data storage processing function can be embodied in various manners or modes, in order to reflect a change in various kinds of print setting with a simple configuration, it is preferable that data should be in a pre-application state in which each print setting has not been applied yet. For example, if the print job data includes data that indicates a print target to which print setting has not been applied yet, it is possible to easily redo and repeat the application of desired print setting to the pre-application print target to which the print setting has not been applied yet all over again any number of times.

In a print setting application technique according to an aspect of the invention, a print setting acquiring function can be embodied in various manners or modes as long as it is possible to acquire information that indicates that print setting has been changed. Therefore, in a case where print setting is identified on the basis of information that indicates the type of print setting and information that indicates the set content of print setting, it is possible to adopt such a configuration that recognizes that at least one of a plurality of print settings has been changed when either the type of print setting or the set content of print setting, or both the type of print setting and the set content of print setting, has/have been changed. The storage of the print job data can be performed in various manners or modes as long as the print job data is stored in such a state that enables the application of changed print setting. For example, in a configuration for performing print-setting change processing on a trial basis, it suffices that the print job data is stored in a predetermined storage medium until print setting that has been definitely determined after the completion of the trial processing is applied to each print target.

In a print setting application technique according to an aspect of the invention, a filter processing function can be embodied in various manners or modes as long as it is possible to perform processing for applying each of a plurality of print settings, which can be applied to a print target, to the print target and generating data that shows a result of the application of changed print setting thereto. For example, a plurality of filters each of which performs processing corresponding to one of a plurality of print settings while enabling the specifying of the set content of print setting is provided. In addition, it is configured that processing that reflects a change is performed for print setting whose set content has been changed. By this means, it is possible to embody the filter processing function explained above.

The technical concept of the invention may be applied to a configuration in which a printer driver applies print setting after the issuance of a print job. That is, in a configuration in which a printer driver applies a plurality of print settings to a print target that is designated by print job data in a fixed sequential order that has been determined in advance at the time when the printer driver executes printing on the basis of the print job data, a plurality of print settings that is applicable to the print setting acquiring function according to an aspect of the invention is configured to be the same as the plurality of print settings that is applied by the printer driver.

With such a configuration, it is possible to change print setting even after the issuance of a print job for performing print processing by means of the printer driver. Needless to say, in such a configuration, it is preferable that the filter processing function should be embodied as an element or the like that is provided with a plurality of filters each of which corresponds to one of a plurality of print settings that can be dealt with by the printer driver. With such a preferred configuration, it is possible to implement the filter processing function according to an aspect of the invention by utilizing the core logic of the filters provided in the printer driver. An example of the printer driver mentioned above is an XPS printer driver, which performs processing on the basis of print job data conforming to XPS specification. An XPS printer driver performs the application of a plurality of print settings in sequential order that has been determined in advance. After the application thereof, the XPS printer driver transfers the applied data to a printer. Filter processing that embodies the filter processing function according to an aspect of the invention is performed before the execution of each print setting in the XPS printer driver. By this means, it is possible to make print setting on a trial basis even after the issuance of a print job in such a configuration that an XPS printer driver applies print setting.

Furthermore, in a print setting application technique according to an aspect of the invention, a display controlling function can be embodied in various manners or modes as long as it is possible to display print-setting-application-completed information on a predetermined display unit so as to allow a user to visually recognize a post-application state in which changed print setting has been applied to a print target. Therefore, the content of display is not restrictively specified herein. As a non-limiting example of various manners or modes of display, a configuration that allows a user to visually recognize both a pre-application state before the application of print setting and a post-application state after the application of print setting may be adopted.

For example, print setting yet-to-be-applied information, which is information that indicates a pre-application state in which none of a plurality of print settings has been applied to a print target contained in print job data yet, is generated. The generated print setting yet-to-be-applied information is displayed on a predetermined display unit. With such a configuration, it is possible to enable a user to visually recognize the pre-application state in which the print setting has not been applied yet (e.g., an original state of a document created with the use of an application program). In addition, it is configured in such a manner that the user can arbitrarily select a print target(s) among a plurality of print targets shown by the print setting yet-to-be-applied information. Moreover, print-setting-applied information, which is information that shows a result of application of the print setting to the selected print target, is displayed on the display unit. With such a configuration, it is possible to provide a user interface that enables desired print setting to be applied to an arbitrarily selected print target. Therefore, even after the issuance of a print job, it is possible to carry out a trial before the execution of printing in order to ensure that desired content should be set for desired print setting and thereafter execute printing.

The technical approach and methodology of the invention, which can be roughly summarized as, without any intention to excessively limit the scope of the invention, the storing of print job data and the application of print setting while referring to the stored print job data when a print-setting change is made, can be practically implemented as, for example, a program, an apparatus, or a method. When the technical concept of the invention is applied to an invention category of an apparatus, the apparatus to which the technical concept of the invention is applied can be embodied in various manners or modes. For example, the apparatus to which the technical concept of the invention is applied may be embodied as a single apparatus or a combination of a plurality of apparatuses. The same holds true for a method and a program. For example, a program, an apparatus, and a method according to an aspect of the invention can be embodied through the functioning of a computer and a printing apparatus in cooperation with each other. In addition, they can be changed, adapted, or modified in various ways. One part thereof may be embodied as software whereas the other part may be embodied as hardware. In addition to a program, an apparatus, and a method, the technical concept of the invention can be embodied as a storage medium in which a program for controlling a printing apparatus is stored. Needless to say, such a software storage medium may be selected among various kinds of storage media including but not limited to a magnetic recording medium and a magneto-optic recording medium. In addition to these existing and known storage media, any new type of a storage medium that will be developed in future may be used as a storage medium according to an aspect of the invention.

### BRIEF DESCRIPTION OF THE DRAWINGS

The invention will be described with reference to the accompanying drawings, wherein like numbers reference like elements.

FIG. 1 is a block diagram that schematically illustrates an example of the configuration of a print control apparatus according to an exemplary embodiment of the invention.

FIG. 2 is a flowchart that schematically illustrates an example of print control processing according to an exemplary embodiment of the invention.

FIG. 3 is a flowchart that schematically illustrates an example of filter processing according to an exemplary embodiment of the invention.

FIG. 4 is a diagram that schematically illustrates an example of a preview UI according to an exemplary embodiment of the invention.

### DESCRIPTION OF EXEMPLARY EMBODIMENTS

In the following description, exemplary embodiments of the present invention are explained in order to clarify the technical concepts of the invention summarized as above. The exemplary embodiments of the invention are organized into the following three sections in this specification.

1. Configuration of Print Control Apparatus

2. Print Control Processing

3. Other Embodiments

### 1. Configuration of Print Control Apparatus

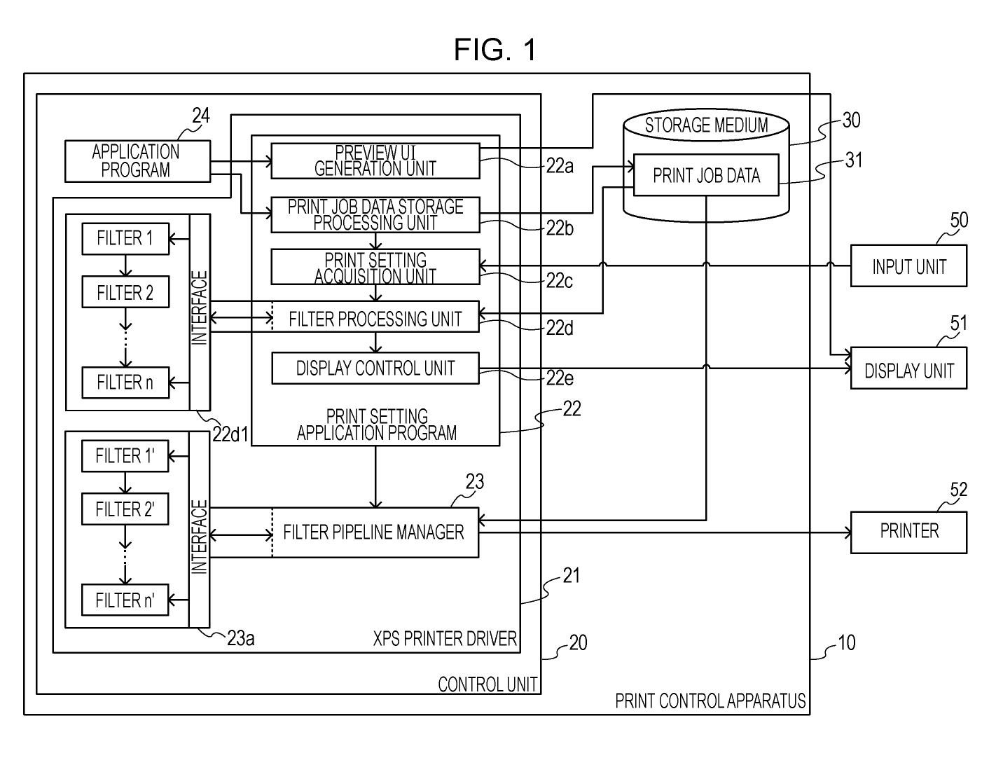

FIG. 1 is a block diagram that schematically illustrates an example of the configuration of a print control apparatus 10 according to an exemplary embodiment of the invention. The print control apparatus 10 is provided with a control unit 20 and a storage medium 30. Being provided with a RAM, a ROM, a CPU, and the like, the control unit 20 is capable of executing programs that are stored in the ROM and the storage medium 30. In the present embodiment of the invention, the control unit 20 is capable of executing an XPS printer driver 21 as a kind of the programs, application programs, and the like. The XPS printer driver 21 is made up of program modules that are used for implementing various kinds of functions. Specifically, the XPS printer driver 21 has a function of receiving the set content of print setting. The XPS printer driver 21 has another function of performing processing for printing a print target to which the print setting for the received set content has been applied.

The print control apparatus 10 is further provided with an interface that is not illustrated in the drawing. The print control apparatus 10 is connected through the interface to an input unit 50, a display unit 51, and a printer 52. The input unit 50 is an input device such as a mouse, a keyboard, or the like. The input unit 50 outputs a signal corresponding to the content of an input made by a user. The control unit 20 identifies the content of the user input on the basis of the signal supplied from the input unit 50. The display unit 51, which is a display device or the like, displays an image in accordance with a signal that is outputted from the control unit 20. The printer 52 is a printing device that prints an image on the basis of print data that is outputted from the control unit 20. The print data represents the image that is to be printed by the printer 52. In the present embodiment of the invention, the printer 52 performs printing on the basis of print data that has been subjected to rendering and then outputted from the control unit 20.

An application program 24 is a module that causes the control unit 20 to implement a function of receiving the content of input operation made through the input unit 50 and creating a text, an image, or the like. The XPS printer driver 21 is a module that causes the control unit 20 to implement a function of receiving each print setting on the basis of print job data that designates a print target and applying the print setting. That is, when a user instructs the execution of printing (i.e., the input issuance of a print job) on the basis of processing of the application program 24, the control unit 20 starts processing by means of the XPS printer driver 21, where print job data that designates a print target that is under the print execution instruction is taken as a processing target.

The XPS printer driver 21 is provided with a print setting application program 22 and filters 1 to n as a program module for changing print setting on a trial basis. The XPS printer driver 21 is further provided with a filter pipeline manager 23 and filters 1′ to n′ as a program module for applying the print setting after the completion of the changing of the print setting so as to carry out printing.

The filters 1′ to n′ (where “n” is an integer of two or greater) perform processing for applying a plurality of print settings to a print target that is written in the format of print job data in XML paper specification (i.e., XPS specification). These filters 1′ to n′ are ones which an ordinary XPS printer driver is provided with in order to deal with print job data in XPS specification. Therefore, the sequential order of processing of these filters 1′ to n′ has been determined in advance and thus cannot be changed. The filter n′, which is the last in the sequential order of processing execution, is a filter that is used for rendering.

That is, the filter n′ performs a series of processing including processing for converting XMS-base data that has been processed by the antecedent filters before the processing of the filter n′ into bitmap data, color-conversion processing, halftone processing, and permutation/rearrangement processing. The filter n′ performs the series of processing described above so as to generate such print data that can be executed for printing by the printer 52. The filters 1′ to (n−1)′ applies a change in print setting by changing XML-base data. Print setting according to the present embodiment of the invention is identified on the basis of information that indicates the type of print setting such as a stamp mark superposition function, an enlarging/contracting function (i.e., scaling function), an Nup function, and the like, and further on the basis of information that indicates the set content of print setting such as a stamp type, a ratio of enlargement/contraction (i.e., scaling factor), an N value in Nup, and the like. The type of print setting and the set content of print setting are written in the format of XML-base data. Accordingly, the filters 1′ to (n−1)′ applies a change in print setting by editing data that contains the description of the type of print setting corresponding to each filter and the set content of print setting.

A print job according to the present embodiment of the invention has a hierarchical structure in order to deal with print job data in XPS specification. That is, one print job is made up of one or more documents. One document is made up of one or more pages. A print target can be selected arbitrarily among pages that make up a job and a document(s). In addition, print job data in XPS specification can incorporate information on the correspondence between print setting that is to be applied and a job, a document, and a page, which is a so-called print ticket. In the application program 24, it is possible to specify print setting at the time when a print job is issued. In such print setting specification at the time of the issuance of a print job, print job data is made up of information that indicates each page to which print setting has not been applied and information (print ticket) that indicates the type of print setting that is to be applied and the set content of print setting in association with a job, a document, and a page.

The control unit 20 performs processing for applying the filters 1′ to n′ to a print target through the processing of the filter pipeline manager 23. That is, at the time when the execution of printing is instructed with the use of a preview UI that is displayed on the display unit 51, the control unit 20 issues an instruction to the filters 1′ to n′ through an interface so that print setting that has been determined at that point in time should be applied to a print target. A more detailed explanation of the preview UI will be given later. Then, print data that is generated as a result of rendering processing performed by the filter n′ is outputted to the printer 52. The printer 52 executes printing on the basis of the print data.

The print setting application program 22 includes a preview UI generation unit 22a, a print job data storage processing unit 22b, a print setting acquisition unit 22c, a filter processing unit 22d, and a display control unit 22e. The control unit 20 causes the preview UI generation unit 22a to perform processing for displaying, on the display unit 51, a preview UI that is to be used for effecting a print-setting change on a trial basis. In addition, the control unit 20 causes the print job data storage processing unit 22b to perform processing for storing print job data that designates a print target into the storage medium 30 (print job data 31). The print job data 31 will be subjected to filter processing of the print setting application program 22 and the filter pipeline manager 23 as a filter-processing target.

Moreover, the control unit 20 causes the print setting acquisition unit 22c to perform processing for acquiring a signal that indicates the operation of a user made over the preview UI through the input unit 50, thereby acquiring information on the type of print setting that is to be changed (i.e., change target) and the set content of the print setting that is to be changed. That is, when a print setting change has been made on the selected print setting, the content of the change is acquired.

Furthermore, the control unit 20 causes the filter processing unit 22d to perform processing for applying print setting to the selected page while referring to the print job data 31. In the present embodiment of the invention, the filters 1 to n (where “n” is an integer of two or greater) are capable of performing processing for applying filter processing in ascending numerical order. The filter processing unit 22d can specify data that designates a processing-target page via a predetermined interface and cause them to start the application of filtering processing. That is, the control unit 20 acquires information on the type of the selected print setting and the set content of the selected print setting explained above, issues via an interface an instruction to the effect that print setting in accordance with the set content should be applied, and extracts a processing-target page out of the print job data 31 and applies the filters 1 to n thereto through the processing of the filter processing unit 22d.

The core logic of the respective filters 1 to n is the same as the core logic of the respective filters 1′ to n′. The interface of the filters 1 to n is different from the interface of the filters 1′ to n′. That is, in order to cause the control unit 20 to perform processing for previewing the content of the change of print setting, the filters 1 to n are provided with an interface for applying “after-the-change” print setting, that is, print setting subjected to the change, to a target of print setting change (e.g., a change target page). On the other hand, the filters 1′ to n′ are provided with an interface for applying print setting having the determined set content to all pages so as to generate print data.

As explained above, in the configuration according to the present embodiment of the invention, the core logic of the filters 1 to n is the same as the core logic of the filters 1′ to n′ whereas the interface of the filters 1 to n is different from the interface of the filters 1′ to n′. As in the filters 1′ to n′ explained above, the sequential order of processing of the filters 1 to n has been determined in advance and thus cannot be changed. In addition, the filter n, which is the last in the sequential order of processing execution, is a filter that is used for rendering.

Furthermore, the control unit 20 causes the display control unit 22e to perform processing for displaying print-setting-application-completed information, which is in a post-application state and thus may be hereafter reworded as “print-setting-applied information”, on the preview UI shown on the display unit 51. That is, image data that indicates the result of rendering processing performed by the filter n is acquired; and then, the print-setting-application-completed information is displayed on the display unit 51 on the basis of the image data. When the print-setting-application-completed information is displayed on the display unit 51 as explained above, it is possible for a user to perform processing for changing print setting on a trial basis by operating the input unit 50 while monitoring the preview UI that is displayed on the display unit 51.

In the present embodiment of the invention, the control unit 20 is configured to apply the filters 1 to n while making reference to the print job data 31 in order to reflect a change in print setting. Therefore, even in a case where the changing of print setting has been made, it is possible to apply after-the-change print setting by referring to the print job data 31 again and performing the processing of the filters 1 to n again. In addition, since data that indicates each print target in the print job data 31 indicates a pre-application print target, which is in a state before the application of print setting, it is possible to redo and repeat the application of desired print setting all over again any number of times so as to make a print-setting change on a trial basis.

### 2. Print Control Processing

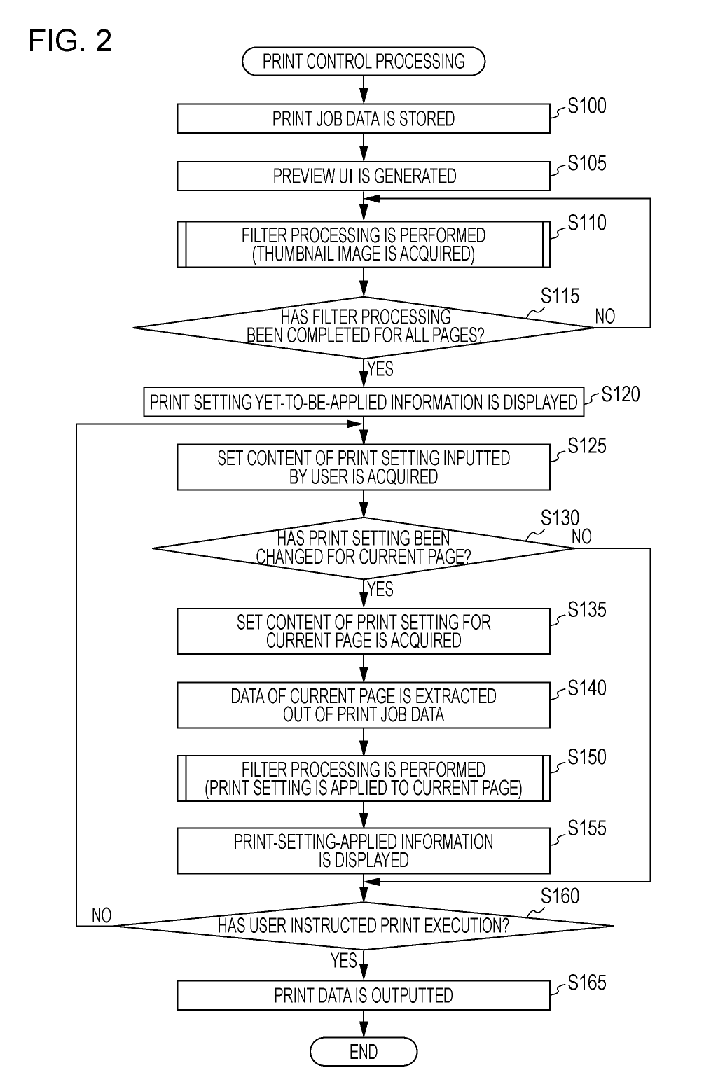

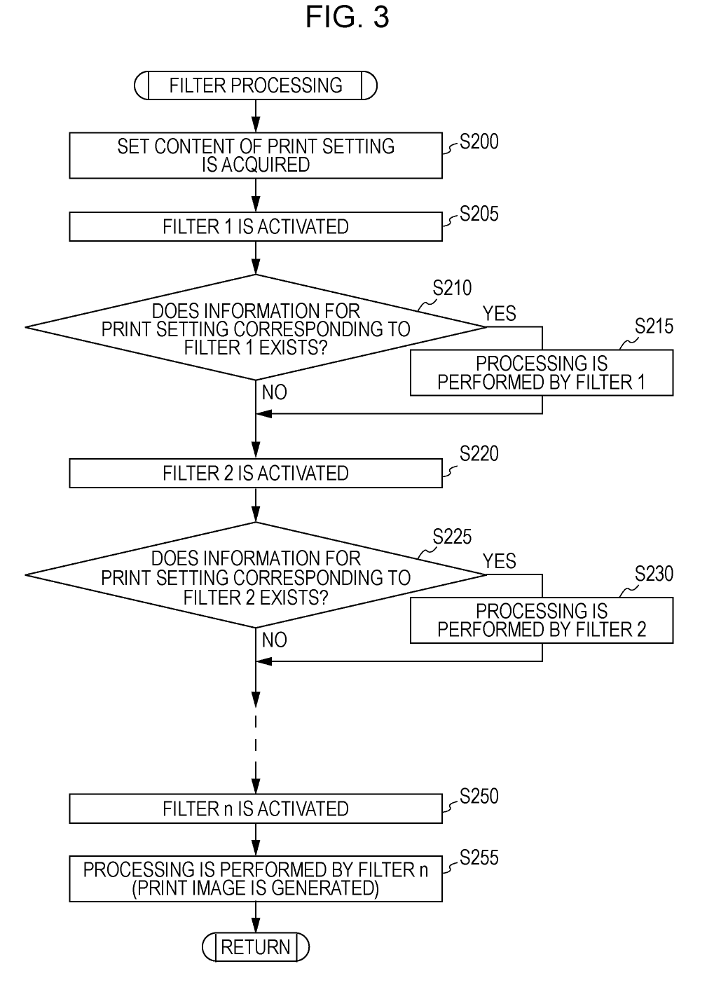

Next, in the following description, an explanation is given of print processing performed by the print control apparatus 10 having the configuration explained above. Upon the instruction of print execution on the basis of processing of the application program 24, the control unit 20 launches the XPS printer driver 21 so as to perform processing illustrated in FIGS. 2 and 3. In this processing, the control unit 20 causes the print job data storage processing unit 22b to perform processing for storing the print job data 31 into the storage medium 30 (step S100).

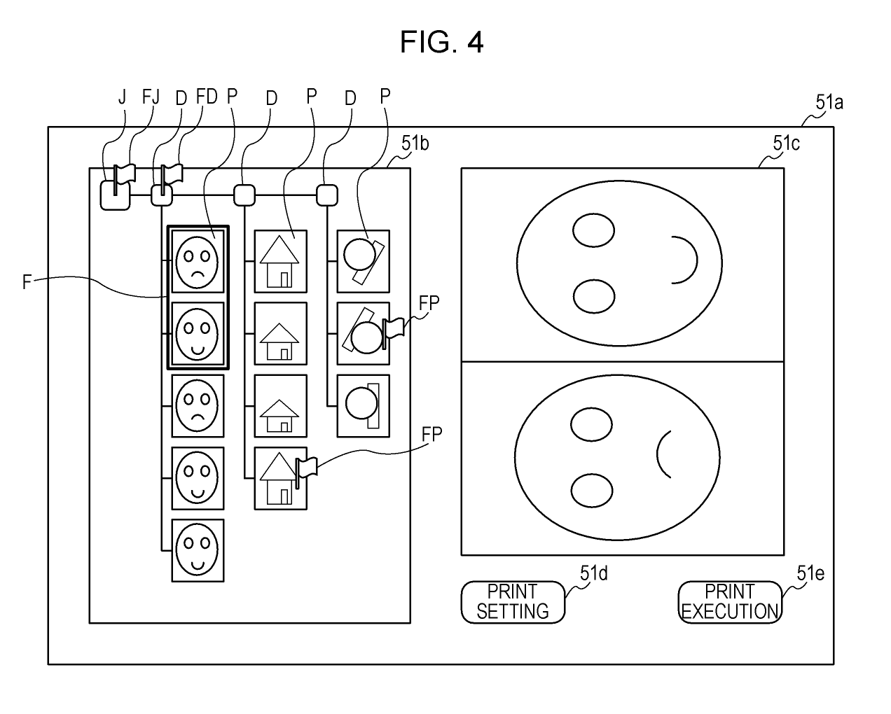

Next, the control unit 20 causes the preview UI generation unit 22a to perform processing for generating a preview UI (step S105). FIG. 4 is a diagram that schematically illustrates an example of a preview UI according to the present embodiment of the invention. As illustrated in FIG. 4, a print setting yet-to-be-applied information 51b is shown inside a rectangular preview window 51a at the left side thereof. The print setting yet-to-be-applied information may be hereafter reworded as “print setting not-yet-applied information” or simply as “print setting unapplied information”. As further illustrated therein, a print-setting-applied information 51c is shown inside the preview window 51a at the right side thereof. The print setting not-yet-applied information 51b is information that indicates that none of a plurality of print settings has been applied yet to a print target that is contained in the print job data 31. On the other hand, the print-setting-applied information 51c is information that indicates a result of application of, for print setting whose set content has been changed, the set content to a print target. In the present embodiment of the invention, the print-setting-applied information 51c is displayed for a print target that is arbitrarily selected among print targets.

In the step S105 explained above, information that indicates the hierarchical structure of the print job data 31 together with the frame of the preview window 51a are generated and then displayed on the display unit 51. Since the print job data 31 is data conforming to XPS specification, a print target is written in such a hierarchical structure that a job, a document, and a page correspond to an upper layer, a middle layer, and a lower layer, respectively. Therefore, in the step S105, the hierarchical structure is displayed in the preview window 51a on the basis of the information that indicates the hierarchical structure. In addition, information that explicitly shows that print setting has already been defined is displayed together therewith in the preview window 51a.

In the illustrated example of FIG. 4, the information that indicates the hierarchical structure is displayed as a part of the print setting yet-to-be-applied information 51b. More specifically, icons J, D, and P are shown inside a rectangular frame of the print setting yet-to-be-applied information 51b. The icon J, which has the shape of a square that has rounded corners, represents a job. The icon D, which also has the shape of a rounded square, represents a document. The icon P, which has the shape of a rectangle, represents a page. In the illustrated example of FIG. 4, one job includes three documents. These three documents include five pages, four pages, and three pages, respectively. As illustrated therein, the icons D of three documents included in a certain job, which is shown as the icon J, are aligned with one another. The icon J is shown at the left of these icons D. A straight horizontal line goes from the rightmost icon D through the remaining two icons D and further extends to the icon J shown at the leftmost extension position. With such line-connection array of the icons J and D, in the step S105, it is explicitly shown that the job contains three documents that lie in a document layer under the job layer. Each page, which is shown as the icon P, is connected to a vertical line that goes downward from the icon D of a document to which the page belongs.

In addition, flag icons FJ, FD, and FP are shown in the preview window 51a. These flag icons FJ, FD, and FP indicate that print setting has already been defined. Specifically, the flag icon FJ indicates that some kind of print setting has already been defined for the job. The flag icon FD indicates that some kind of print setting has already been defined for a document. The flag icon FP indicates that some kind of print setting has already been defined for a page. That is, since the print setting yet-to-be-applied information 51b that is displayed in the preview window 51a shows a pre-application state in which print setting has not been applied yet, each of the flag icons FJ, FD, and FP is used to indicate that some kind of print setting has already been defined for an item (i.e., the job, a document, or a page) marked with the flag icon.

Since print setting can be defined for an item belonging to each layer, there is a possibility that multiple print-setting definitions are made. In such a case, it is possible to decide print setting that should be applied to the item on the basis of a predetermined order of priority in the application of print setting. For the purpose of explanation, it is assumed herein that it has been determined in advance that a higher priority in the application of print setting should be given to print setting defined for a lower layer. It is further assumed herein that a certain print setting is defined for a certain page and that another print setting is defined for the job. In this multiple-definition example, the print setting defined for the page, which lies in a lower layer, is accorded priority over the print setting defined for the job. Therefore, the print setting defined for the page is applied to the page.

As explained above, information that indicates the hierarchical structure of the print job data 31 together with the frame of the preview window 51a are displayed in the step S105. Thereafter, the control unit 20 performs a series of processing for displaying the print setting yet-to-be-applied information 51b in steps S110 to S120. Then, the control unit 20 performs a series of processing for displaying the print-setting-applied information 51c in steps S125 to S155.

Specifically, in order to acquire a thumbnail image for each of pages that are contained as a print target in the print job data 31, the control unit 20 causes the filter processing unit 22d to perform filter processing (step S110). In a step S115, the control unit 20 makes a judgment as to whether thumbnail image acquisition filter processing has been completed for all pages that are contained in the print job data 31 or not. If the control unit 20 judges that the filter processing has not been completed for all pages yet, the control unit 20 causes the filter processing unit 22d to repeat the step S110 for the remaining pages for which the filter processing has not been performed yet. FIG. 3 is a flowchart that schematically illustrates an example of filter processing according to the present embodiment of the invention. In the filter processing illustrated therein, the control unit 20 acquires print setting through the processing of the filter processing unit 22d (step S200). The plurality of filters 1 to n corresponds to a plurality of print settings, respectively. These filters 1 to n identify print setting on the basis of a parameter transferred to each filter and perform filter application processing on a processing-target page.

Accordingly, in the step S200, the control unit 20 acquires information that indicates print setting. The print setting is selected in accordance with a processing stage (i.e., processing step) in the flowchart illustrated in FIG. 2. In the step S110 illustrated in FIG. 2, filter processing is performed in order to acquire a thumbnail image of each page in a pre-application (i.e., “before-the-application”) state in which print setting has not been applied thereto. Therefore, in the step S110, processing is performed by means of the filter n, which performs rendering, only. The other filters are not applied in this step. For this reason, when the filtering process illustrated in FIG. 3 is initiated in the step S110, a plurality of print settings that corresponds to the filters 1 to (n−1) has not been defined for any of processing-target pages.

In accordance with the print setting, the filter processing illustrated in FIG. 3 is performed in the same processing sequence for each of the filters 1 to (n−1). For example, steps S205 to S215 are processing related to the filter 1 whose processing sequence is the same as the processing sequence of steps S220 to S230, which are processing related to the filter 2. Note that processing for the filters 3 to (n−1) is not shown in FIG. 3.

Since the processing sequence is the same for each of the filters 1 to (n−1), the processing sequence of the filter 1 is explained below. First, the control unit 20 activates the filter 1 to perform filter processing (step S205). Then, the control unit 20 makes a judgment as to whether information that specifies the set content of the print setting that corresponds to the filter 1 exists or not (step S210). If the control unit 20 judges in the step S210 that information that specifies the set content of the print setting that corresponds to the filter 1 exists, data of a processing-target page is extracted with reference to the print job data 31 so that the processing is performed by the filter 1; and as a result thereof, the print setting including the set content is applied (step S215). The step S215 is skipped if the control unit 20 judges in the step S210 that information that specifies the set content of the print setting that corresponds to the filter 1 does not exist.

In the same manner, in each of the filters 2 to (n−1), processing for applying the print setting including the set content is performed when information that specifies the set content of the print setting that corresponds to the filter exists. In the present embodiment of the invention, the processing of the filter n is always performed because the filter n is one that performs rendering. Specifically, the control unit 20 activates the filter n after the completion of processing related to the filter (n−1) (step S250). The filter n performs processing on data that has been subjected to the filter application processing of the filters 1 to (n−1), which was performed if the information exists, thereby generating a print image for the processing-target page (step S255).

Note that processing for applying the plurality of print settings corresponding to the filters 1 to (n−1) is not performed at the processing stage of the step S110 illustrated in FIG. 2. For this reason, when a sub routine that is illustrated in FIG. 3 is executed in the step S110, a print image in a pre-application state in which print setting has not been applied yet is generated. Therefore, in the step S110, pixel-skipping processing or size-reduction processing is performed in accordance with the pre-application print image so as to acquire a thumbnail image of the print-target page. Following the acquisition of the thumbnail image of the print-target page as explained above in the step S110, if it is judged in the step S115 that thumbnail image acquisition filter processing has been completed for all pages that are contained in the print job data 31, it is recognized that thumbnail images for all of the pages has been acquired.

After the acquisition of the thumbnail images for all of the pages, the control unit 20 causes the display control unit 22e to perform processing for displaying these thumbnail images as a part of the print setting yet-to-be-applied information 51b on the display unit 51 (step S120). In the illustrated example of FIG. 4, the page icon P is the thumbnail of a print image of each page.

Next, the control unit 20 acquires print setting inputted by a user (step S125). That is, when a user inputs some set content of a certain print setting for a certain page that is contained in a print job by operating the input unit 50, the control unit 20 acquires the user-inputted set content. Then, the control unit 20 makes a judgment as to whether print setting has been changed for a current page(s) or not (step S130).

In the illustrated example of FIG. 4, a print setting execution button 51d is shown at the lower part of the preview window 51a near the center thereof when viewed in the horizontal direction. The current page is a page displayed as the print-setting-applied information 51c after the application of print setting. In the illustrated example of FIG. 4, the current pages are shown as two pages enclosed by a black frame F. When a user clicks the print setting execution button 51d, the control unit 20 commands that a print-setting window should be displayed on the display unit 51. The print-setting window is a user interface window that allows a user to make print setting. Note that the print-setting window is not illustrated in the drawing. Through setting operation on the print-setting window, a user can select any print setting, as they desire, among a plurality of print settings available for printing at the printer 52. In addition, in each selected print setting, the user can further specify the set content thereof. Accordingly, the user can specify the set content of arbitrarily selected print setting while designating any page, document, or job. Moreover, the print-setting window allows a user to issue an instruction for determining the print setting in order to make the setting valid and effective. When an instruction for the determination of the print setting is given, the control unit 20 judges whether the print setting of the current page that has now been determined is the same as the previous setting before the determination. If the print setting of the current page that has now been determined is different from the previous setting before the determination, the control unit 20 judges that the changing of the print setting of the current page has been made valid and effective.

If the control unit 20 judges in the step S130 that print setting has not been changed for the current page, the control unit 20 further makes a judgment as to whether the user has instructed the execution of printing by clicking a print execution instruction button 51e or not (step S160). The series of processing from the step S125 through the step S155 is repeated until it is judged in the step S160 that a print execution instruction has been issued.

On the other hand, if the control unit 20 judges in the step S130 that print setting has been changed for the current page, the control unit 20 performs processing for displaying the print-setting-applied information 51c in accordance with the changed print setting. Specifically, the control unit 20 acquires the print setting for the current page (which is the changed print setting) (step S135). Next, the control unit 20 extracts the data of the current page out of the print job data 31 (step S140). Then, filter processing is performed in order to apply print setting to the current page (step S150). If the current page includes more than one page, the control unit 20 extracts the data of the plurality of pages out of the print job data 31 in the step S140.

Although the filter processing of the step S150 is performed in accordance with the flow illustrated in FIG. 3, the print setting acquired in the step S200 is the setting acquired in the step S135 because the processing-target page in this processing stage is the current page mentioned above. Therefore, as a result of the processing illustrated in FIG. 3, a print image of the current page that is in a state in which the print setting made valid and effective, that is, definitely determined, on the print-setting window has been applied is generated.

Then, process returns to the flow of FIG. 2 after the step S255. Thereafter, the control unit 20 commands that the print-setting-applied information 51c corresponding to the current page should be displayed on the display unit 51 on the basis of the print image explained above (step S155).

In the illustrated example of FIG. 4, the print-setting-applied information 51c shows a state in which the print setting of Nup with the set content of N=2 is applied to the current pages that are enclosed by the black frame F. It should be noted that, though not specifically illustrated in the drawing, the icons FJ, FD, and FP are displayed for the current pages after the definition of print setting so as to indicate that the print-setting definition has been made due to the changing of the print setting.

If the control unit 20 judges in the step S160 that the user has instructed the execution of printing, the control unit 20 outputs print data to the printer 52 (step S165). That is, print setting is definitely determined in accordance with the content inputted in the step S125; and then, the filter processing illustrated in FIG. 3 is performed in accordance with the print setting while taking all of the pages contained in the print job data 31 as a processing target. That is, the filter processing illustrated in FIG. 3 is performed in accordance with the print setting for all pages that are included in the print job data 31. As a result, print data that shows a print image for all of the pages contained in the print job data 31 is created. The control unit 20 outputs the print data to the printer 52 and commands that printing should be performed.

Through the processing explained above, it is possible for a user to obtain information on pre-application pages, which are in a state in which print setting has not been applied yet, and information on the hierarchical structure of a print job on the basis of the print setting yet-to-be-applied information 51b. In addition, it is possible for the user to obtain information on a result of the application of desired print setting to a current page on the basis of the print-setting-applied information 51c. In addition, a print-setting window enables the user to set the content of arbitrarily selected print setting as they desire. Through the changing of print setting while selecting a desired page(s) as the current page, it is possible for a user to change the print setting of the desired page. Therefore, even after the issuance of a print job through the operation of the application program 24, print setting can be changed. In addition, it is possible to make print setting on a trial basis before the execution of printing. Moreover, in print setting application according to the present embodiment of the invention, since it is possible to set any page as a current page, it is possible to easily define print setting for an arbitrary target unit by making print setting while taking any page, document, or job as the target unit.

### 3. Other Embodiments

The foregoing embodiment of the invention is nothing more than a specific example of the technical concept of the invention. Other various embodiments, variations, modifications, and the like can be adopted without departing from the gist of the invention, that is, the storing of print job data and the application of print setting while referring to the stored print job data when a print-setting change is made. For example, although it is explained in the foregoing exemplary embodiment of the invention that a thumbnail image for each of pages that constitute a print job is acquired through filter processing, thumbnail data may be simply extracted out of the print job data 31 instead of performing filter processing if the print job data 31 contains a thumbnail image for each page.

It is explained in the foregoing exemplary embodiment of the invention that the core logic of the filters 1 to n is the same as the core logic of the filters 1′ to n′. Accordingly, two filters are provided for each print setting. However, the scope of the technical concept of the invention is not limited to such an exemplary configuration. Only one filter may be provided for each print setting. For example, in the configuration of the print control apparatus 10 illustrated in FIG. 1, the filters 1′ to n′ may be omitted; in such a modified configuration, an interface is shared so that both of the filter processing unit 22d and the filter pipeline manager 23 can use the interface for the execution of filter processing by the filters 1 to n. That is, the filters 1 to n are used both for filter processing at the time of print execution and for filter processing at the time of making print setting on a trial basis. With such a configuration, it is possible to save resources.

Furthermore, a manner of displaying information in the preview window 51a is not limited to a specific example illustrated in FIG. 4. For example, the print-setting-applied information 51c may be displayed by performing filter processing for all pages whose print setting has been changed.

The entire disclosure of Japanese Patent Application No. 2008-249807, filed Sep. 29, 2008 is expressly incorporated by reference herein.

What is claimed is:

1. A print setting application apparatus comprising:
a print job data storage processing section that causes a predetermined storage medium to store print job data that designates a print target;
a print setting acquiring section that acquires information that indicates that at least one of a plurality of print settings that can be applied to the print target has been changed; and
a display controlling section that causes a predetermined display unit to display print-setting-application-completed information, which shows a result of application of the changed print setting to the print target when the print setting has been changed,
wherein the plurality of print settings that can be applied to the print target is the same as a plurality of print settings that is applied in a predetermined sequential order to the print target designated by the print job data at the time when a printer driver executes printing, and
the print target of the print job data stored through the processing of print job data storage processing section constitutes data that represents a state in which the print setting has not been applied yet.

2. A print control apparatus comprising:
the print setting application apparatus according to claim 1; and
a print controlling section that generates print data by applying the changed print setting to the print target and then controlling a printing device on the basis of the print data.

3. A print setting application method comprising:
print job data storage processing of causing a predetermined storage medium to store print job data that designates a print target;
print setting acquisition of acquiring information that indicates that at least one of a plurality of print settings that can be applied to the print target has been changed; and
display controlling of causing a predetermined display unit to display print-setting-application-completed information, which shows a result of application of the changed print setting to the print target when the print setting has been changed.
